(19) United States
(12) Patent Application Publication
(10) Pub. No.: US 2005/0195539 A1
(43) Pub. Date: Sep. 8, 2005

(54) Method and device for ESD protection of a display

(75) Inventors: Sheng-Chieh Yang, Taoyuan City (TW); An Shih, Chuanghua Hsien (TW)

Correspondence Address: LIU & LIU, 444 S. FLOWER STREET SUITE 1750, LOS ANGELES, CA, 90071, US

(73) Assignee: Toppoly Optoelectronics Corp.

(21) Appl. No.: 10/857,529

(22) Filed: May 27, 2004

(30) Foreign Application Priority Data
Mar. 3, 2004 (TW) 93105494

(51) Int. Cl. H02H 9/00

(52) U.S. Cl. 361/56

(57) ABSTRACT

The present invention provides a method and device for electrostatic discharge (ESD) protection of a display. A first terminal is coupled to an electrostatic source. A second terminal is coupled to the electronic element. A circuit conductively couples the first terminal to the second terminal, wherein the circuit comprises a plurality of signal lines couple in parallel between the first and the second terminals, and a plurality of ESD units each couple to a signal line.

### BACKGROUND OF THE INVENTION

1. Field of the invention

The present invention relates to a method and device for ESD protection, and more particularly to a method and device for raising ESD endurance of a display.

2. Description of the Related Art

ESD management is an increased reliability issue in complementary metal oxide semiconductor (CMOS) integrated circuits (ICs) due to technology scaling and high frequency requirements. For radio frequency (RF) ICs, on-chip ESD protection design suffers from several limitations, such as low parasitic capacitance, constant input capacitance, and insensitivity to substrate coupling noises. In order to fulfill these requirements, diodes are commonly used for ESD protection in I/O circuits.

In the above, the power-rail ESD clamp circuit is important for improving the ESD protection in IC products, but must be triggered efficiently during ESD events.

Thin film transistor (TFT) of low temperature poly-silicon (LTPS) has higher mobility and lower threshold voltage, but displays composed LTPS-TFT accumulate significant charge, posing danger to transistors of internal driving circuits. Therefore, an ESD protection circuit is necessary for an LTPS-TFT display.

FIG. 1 shows a conventional ESD protection circuit for an LTPS-TFT display, wherein P-type metal-oxide-semiconductor (PMOS) transistors MPᵢ₋ⱼ and N-type metal-oxide-semiconductor (NMOS) transistors MNᵢ₋ⱼ are utilized to discharge an ESD pulse from an input signal terminal Tᵢ to a power line with a supply voltage of V_{dd} or Vₛₛ, preventing the ESD pulse from entering a signal terminal Tₒ and damaging the internal driving circuit.

Generally, the conventional ESD protection circuit is disposed as a “lateral layout” as shown in FIG. 2, wherein the ESD protection units, such as the PMOS transistors MPᵢ₋ⱼ and the NMOS transistors MNᵢ₋ⱼ, are disposed laterally to avoid the input signal line Tᵢ-Tₒ. In addition to the low area-efficiency of the lateral layout, due to the various distances from each PMOS transistor MPᵢ₋ⱼ or each NMOS transistor MNᵢ₋ⱼ to the input signal line Tᵢ-Tₒ, the MOS transistors are switched on gradually as the current passes, one by one. For example, the MOS transistors (MPᵢ, MNᵢ) near the input signal lines Tᵢ-Tₒ are switched on earlier than the MOS transistors (MPⱼ, MNⱼ) farther from the input signal line Tᵢ-Tₒ. The asynchronous switching compromises the ESD protection ability of the circuit, whereby damage of a near-end MOS transistor can severely affect the performance of the ESD protection circuit.

### SUMMARY OF THE INVENTION

Accordingly, the present invention provides a novel layout of ESD protection circuits for a display with enhanced protection and increased the utility rate of the peripheral area. Generally, the present invention provides a circuit configuration for ESD protection of electronic elements by coupling the input terminal To for static discharge to the input terminal Ti to internal circuits of the electronic elements, in a manner in which ESD protection units are arranged in parallel between To and Ti.

To achieve the above objects, the invention provides an electrostatic discharge (ESD) protection device for an electronic element, which comprises a first terminal coupled to an electrostatic source, a second terminal coupled to the electronic element, a circuit conductively coupling the first terminal to the second terminal, wherein the circuit comprises a plurality of signal lines coupled in parallel between the first and second terminals, and a plurality of ESD units each coupled to a signal line.

The invention further provides an electrostatic discharge (ESD) protection method of a display, which comprises dividing a first input signal line into a plurality of second input signal lines, joining the plurality of second input signal lines to form a third input signal line, coupling to an array circuit of the display, and respectively disposing an ESD protection unit corresponding to each of the plurality of second input signal lines, whereby an ESD pulse from the first input signal line is divided among the plurality of second input signal lines and discharged by the ESD protection unit.

According to the invention, the ESD protection unit may include a diode and/or a metal-oxide-semiconductor transistor, and preferably couples to a power line with a power supply voltage, or a reference voltage.

The display may be an amorphous-silicon thin-film-transistor (TFT) liquid crystal display ,low-temperature poly-silicon (LTPS) TFT liquid crystal display or organic light emitting display (OLED), and the third input signal line may be electrically connected to a gate line or a date line of the display.

The ESD pulse divided among the plurality of second input signal lines enables the ESD protection unit and may be discharged to the power line with the power supply voltage, or the power line with the reference voltage.

The second input signal line preferably has a line width less than that of the first input signal line.

The ESD protection device of the invention preferably further comprises a dividing part between the first input signal line and the second input signal lines, and a joining part between the second input signal lines and the third input signal line, wherein both the dividing part and the joining part have a line width greater than that of the first input signal line and the sum of the second input signal lines.

Accordingly, an ESD protection method and device are presented by modifying the layout of the ESD protection circuit. An input signal line is separated into a plurality of sub-signal lines, and an ESD protection unit is correspondingly disposed around each of the sub-signal lines to form an ESD protection circuit, thereby increasing the utility rate of the peripheral area, furthering the switching speed of each ESD protection circuit, and enhancing the ESD protection ability of the display.

### DESCRIPTION OF THE DRAWINGS

The present invention can be more fully understood by reading the subsequent detailed description and examples with references made to the accompanying drawings, wherein:

FIG. 1 shows conventional ESD protection circuits for a liquid crystal display;

FIG. 2 shows the layout of the conventional ESD protection circuits of FIG. 1;

FIG. 3 shows the inventive layout of the ESD protection circuits in accordance with one embodiment of the present invention;

FIG. 4 is a schematic diagram of a display incorporating the inventive ESD protection circuit configuration in accordance with one embodiment of the present invention; and

FIG. 5 is a schematic diagram of an electronic device, incorporating a display having the inventive configuration of ESD protection circuits in accordance with one embodiment of the present invention.

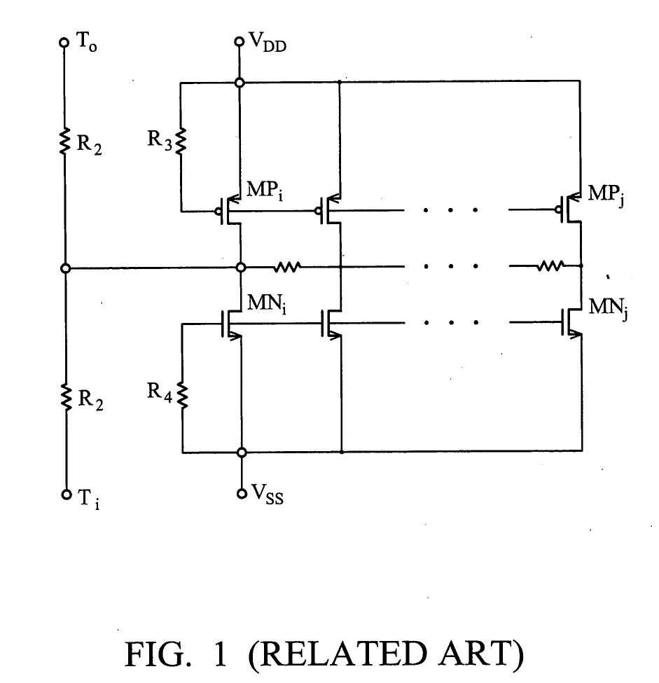

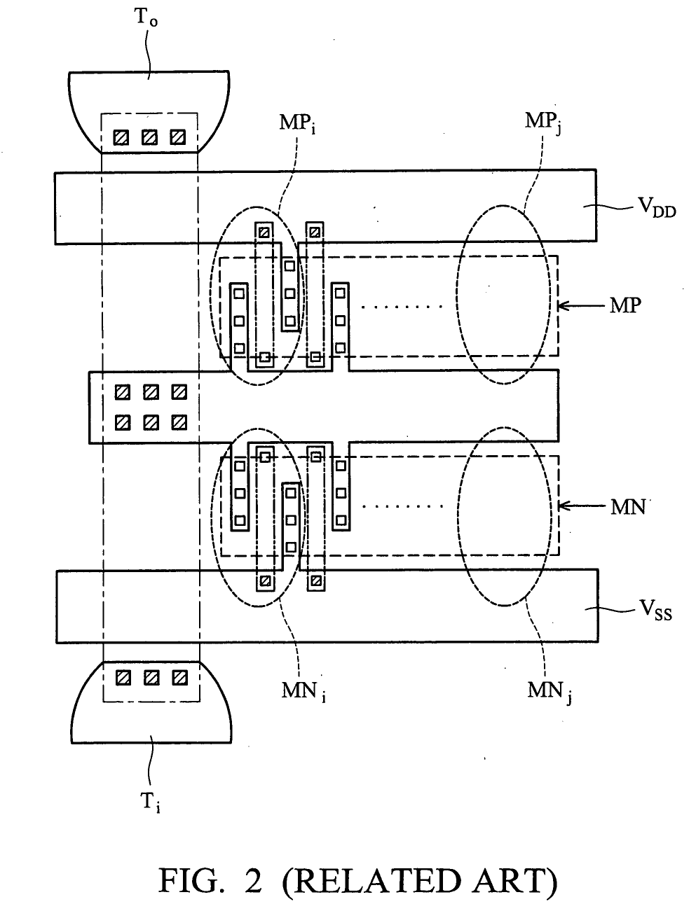

### DETAILED DESCRIPTION OF THE INVENTION

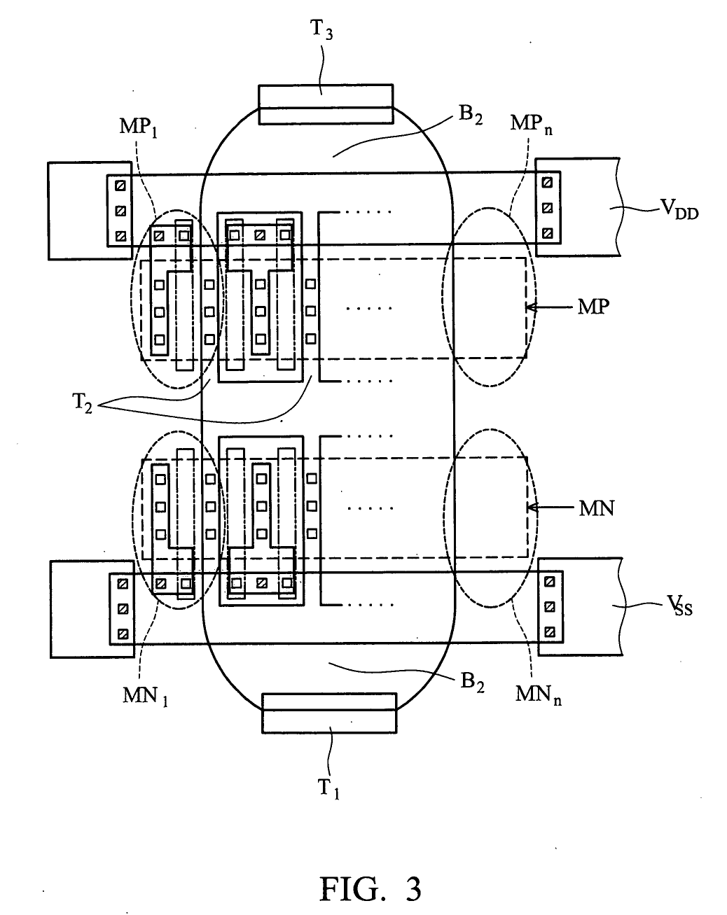

FIG. 3 shows the inventive layout of the ESD protection circuits in accordance with one embodiment of the present invention.

The ESD protection units of the invention may be fabricated before or after formation of the input signal lines. In the embodiment, ESD protection units of PMOS transistors MP₁-MPₙ and NMOS transistors MN₁-MNₙ, equivalent to diodes, are fabricated after input-signal-line fabrication. In addition, diodes may be applied rather than the MOS transistors (MP₁-MPₙ and MN₁-MNₙ).

Accordingly, the ESD protection device of the embodiment comprises the first input signal line T₁, the second input signal lines T₂ separated from the first input signal line T₁, the third input signal line T₃ joined to the second input signal lines T₂, and a plurality of ESD protection units (MPᵢ-MPₙ and MN₁-MNₙ) corresponding to the second input signal lines T₂, whereby an ESD pulse from the first input signal line T₁ is divided among the second input signal lines T₂ and discharged by the ESD protection units (MP₁-MPₙ and MN₁-MNₙ)

Furthermore, as shown in FIG. 3, the second input signal lines T₂ are disposed in parallel, each having a line width less than that of the first input signal line T₁. A dividing part B1, between the first input signal line T₁ and the second input signal lines T₂, has line width exceeding that of the first input signal line T₁ and the sum of the second input signal lines T₂, providing an adequate area for uniformly dividing the ESD pulse among the second input signal lines T₂ and their corresponding ESD protection units (MP₁-MPₙ and MN₁-MNₙ). In addition, a joining part B2, between the second input signal lines T₂ and the third input signal line T₃, has line width exceeding that of the first input signal line T₁ and the sum of the second input signal lines T₂ to provide an adequate area.

Moreover, the ESD protection units (MP₁-MPₙ and MN₁-MNₙ), respectively disposed around the second input signal lines T₂, form a compact layout to increase the utility rate of the periphery. The ESD protection units (MP₁-MPₙ and MN₁-MNₙ), coupling to the second input signal lines T₂, are also coupled to a power line with a power supply voltage (V_{dd} or Vₛₛ). The ESD protection units (MP₁-MPₙ and MN₁-MNₙ) may also be coupled to a power line with a reference voltage, such as ground (not shown).

With the inventive ESD protection device disposed prior to an input signal line, a liquid crystal display, particularly an LTPS liquid crystal display, is protected from ESD damage.

Thus, electrostatic charges are divided from the first input signal line T₁ into the second input signal lines T₂ and the ESD protection units (MP₁-MPₙ and MN₁-MNₙ). The ESD protection units (MP₁-MPₙ and MN₁-MNₙ) are then switched on and the electrostatic charges discharged to the power lines, protecting the internal driving circuit from damage.

According to the inventive ESD protection method, a first input signal line T₁ is divided among a plurality of second input signal lines T₂ in parallel, each having a line width less than that of the first input signal line T₁. The second input signal lines T₂ are then joined to form a third input signal line T₃, coupling to an internal driving circuit of the LCD (not shown). ESD protection units (MP₁-MPₙ and MN₁-MNₙ) are then respectively formed corresponding to each of the second input signal lines T₂, whereby an ESD pulse from the first input signal line T₁ is divided among the second input signal lines T₂ and discharged by the ESD protection units (MP₁-MPₙ and MN₁-MNₙ).

The inventive ESD protection method and device are applicable to displays using TFTs as switching elements, such as amorphous-silicon TFT-LCDs, LTPS TFT-LCDs or OLEDs. The third input signal line T₃ is coupled to a gate line or a data line of the liquid crystal display. ESD pulses entering the first input signal line T₁ are divided among the second input signal lines T₂ and the ESD protection units (MP₁-MPₙ and MN₁-MNₙ). The ESD protection units (MP₁-MPₙ and MN₁-MNₙ) are then switched on and the ESD pulse discharged to the power lines, away from the second input signal lines T₂, and is prevented from entering the third input signal line T₃, such that gate line or the data line of the LCD is protected from ESD damage.

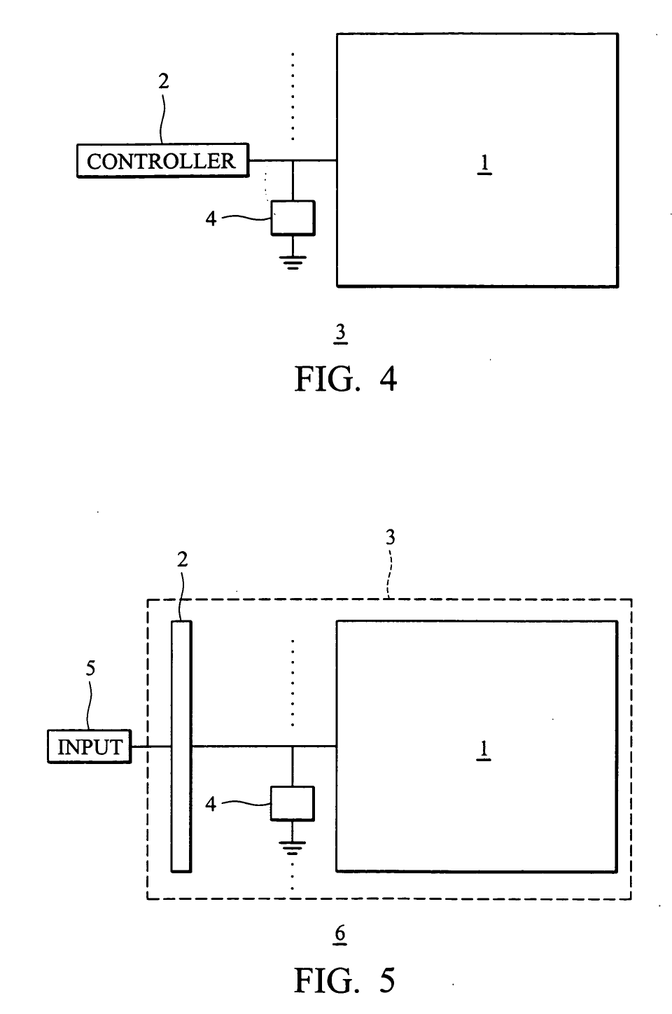

FIG. 4 is a schematic diagram of a display incorporating the inventive ESD protection circuit configuration in accordance with one embodiment of the present invention. The ESD protection devices 4 can be couple to a display panel 1. Each ESD protection device 4 comprises a first terminal coupled to an electrostatic source and a second terminal coupled to each gate line of the display panel 1. The display panel can be coupled to a controller, forming a display device as shown in FIG.3. The controller can comprise a source and a gate driving circuits (not shown) to control the display panel 1 to render image in accordance with an input.

It should be noted that each gate line or data line of the display panel 1 requires an ESD protection unit separately as in FIG. 3.

FIG. 5 is a schematic diagram of an electronic device 6, incorporating a display having the inventive configuration of ESD protection circuits in accordance with one embodiment of the present invention. An input device 5 is coupled to the controller 2 of the display device shown in FIG. 4 can include a processor or the like to input data to the controller 2 to render an image. The electronic device 6 may be a portable device such as a PDA, notebook computer, tablet computer, cellular phone, or a desktop computer.

The foregoing description has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

1. An electrostatic discharge (ESD) protection device for an electronic element, comprising:
a first terminal coupled to an electrostatic source;
a second terminal coupled to the electronic element;
a circuit conductively coupling the first terminal to the second terminal, wherein the circuit comprises a plurality of signal lines coupled in parallel between the first and second terminals, and a plurality of ESD units each coupled to a signal line.

2. The ESD protection device as in claim 1, wherein the electronic element comprises a display panel for a display device.

3. The ESD protection device as in claim 1, wherein the ESD protection unit includes a diode.

4. The ESD protection device as in claim 1, wherein the ESD protection unit includes a metal-oxide-semiconductor transistor.

5. The ESD protection device as in claim 1, wherein the ESD protection unit couples to a power line with a power supply voltage.

6. The ESD protection device as in claim 1, wherein the ESD protection unit couples to a power line with a reference voltage.

7. The ESD protection device as in claim 6, wherein a ESD pulse divided among the plurality of signal lines enables the ESD protection unit and is discharged to the power line with the power supply voltage.

8. The ESD protection device as in claim 7, wherein the ESD pulse divided among the plurality of signal lines enables the ESD protection unit and is discharged to the power line with the reference voltage.

9. The ESD protection device as in claim 1, wherein the signal line has a line width less than that of the first terminal.

10. The ESD protection device as in claim 9, further comprising a dividing part between the first terminal and the signal lines, and a joining part between the signal lines and the second terminal, wherein both the dividing part and the joining part have a line width greater than that of the first terminal and the sum of the signal lines.

11. The ESD protection device as claimed in claim 1, wherein the signal line has a line width less than that of the first terminal.

12. A display device, comprising:
a display panel;
an electrostatic discharge (ESD) protection device, comprising:
a first terminal coupled to an electrostatic source;
a second terminal coupled to the electronic element;
a circuit conductively coupling the first terminal to the second terminal, wherein the circuit comprises a plurality of signal lines coupled in parallel between the first and second terminals, and a plurality of ESD units each coupled to a signal line; and
a controller coupled to the display panel to control the display panel to render an image in accordance an input.

13. An electronic device, comprising:
a display panel;
an electrostatic discharge (ESD) protection device, comprising:
a first terminal coupled to an electrostatic source;
a second terminal coupled to the electronic element; and
a circuit conductively coupling the first terminal to the second terminal, wherein the circuit comprises a plurality of signal lines coupled in parallel between the first and second terminals, and a plurality of ESD units each coupled to a signal line;
a controller coupled to the display panel to control the display panel to render an image in accordance an input; and
an input device couple to the controller of the display device to render an image.

14. An electrostatic discharge (ESD) protection method for a display, comprising:
separating a first input signal line into a plurality of second input signal lines;
joining the plurality of second input signal lines to form a third input signal line, coupled to an array circuit of the display; and
respectively disposing an ESD protection unit corresponding to each of the plurality of second input signal lines, whereby ESD pulse from the first input signal line is divided among the plurality of second input signal lines and discharged by the ESD protection unit.

15. The ESD protection method as claimed in claim 14, wherein the ESD protection unit includes a diode.

16. The ESD protection method as claimed in claim 14, wherein the ESD protection unit includes a metal-oxide-semiconductor transistor.

17. The ESD protection method as claimed in claim 14, wherein the ESD protection unit couples to a power line with a power supply voltage.

18. The ESD protection method as claimed in claim 14, wherein the ESD protection unit couples to a power line with a reference voltage.

19. The ESD protection method as claimed in claim 18, wherein the ESD pulse divided among the plurality of second input signal lines enables the ESD protection unit and is discharged to the power line with the power supply voltage.

20. The ESD protection method as claimed in claim 19, wherein the ESD pulse divided among the plurality of second input signal lines enables the ESD protection unit and is discharged to the power line with the reference voltage.

21. The ESD protection method as claimed in claim 14, wherein the second input signal line has a line width less than that of the first input signal line.
